(19) United States
(12) Patent Application Publication
(10) Pub. No.: US 2014/0343914 A1
(43) Pub. Date: Nov. 20, 2014

(54) SYSTEMS AND METHODS FOR CREATING A MODEL OF COMPOSITION FOR A COMPOSITE FORMED BY COMBINING A PLURALITY OF HYDROCARBON STREAMS

(71) Applicants: Anantha SUNDARAM, Annandale, NJ (US); Liang J CHANG, Reston, VA (US); Dilip BHATTACHARYYA, Toronto (CA); Matthew NAYSMITH, Edmonton (CA); David A JOE, Edmonton (CA); Keith MEDCALF, Calgary (CA); David S SCHULTZ, Reston, VA (US)

(72) Inventors: Anantha SUNDARAM, Annandale, NJ (US); Liang J CHANG, Reston, VA (US); Dilip BHATTACHARYYA, Toronto (CA); Matthew NAYSMITH, Edmonton (CA); David A JOE, Edmonton (CA); Keith MEDCALF, Calgary (CA); David S SCHULTZ, Reston, VA (US)

(73) Assignee: EXXONMOBIL RESEARCH AND ENGINEERING COMPANY, Annandale, NJ (US)

(21) Appl. No.: 13/895,688

(22) Filed: May 16, 2013

(51) Int. Cl. G06F 19/00

(52) U.S. Cl. CPC G06F 19/702
USPC 703/12

(57) ABSTRACT

Systems and methods for creating a model of composition for a current composite created by combining a plurality of hydrocarbon streams. The method comprises receiving at least one primary data value related to the current composite, associating the at least one primary data value with a profile of the current composite, selecting a modeling scenario for the current composite using a hierarchy of modeling scenarios, and creating a model of composition for the current composite using at least one processor, The modeling scenario is selected based at least in part on a collection of primary data values associated with the profile of the current composite. The model of composition is created based at least in part on the modeling scenario and the collection of primary data values associated with the profile of the current composite. Systems of creating the model of composition are also disclosed.

### BACKGROUND OF THE INVENTION

1. Field of the Invention

The disclosed subject matter generally relates to systems and method for generating a model of composition. Particularly, the disclosed subject matter relates to systems and methods for a model of composition for a synthetic crude composition based on limited data.

2. Description of Related Art

Synthetic crudes are expected to become a staple component in many U.S. and Canadian refineries. A synthetic crude is a petroleum stream that is synthetically constructed as a mixture of several component hydrocarbon streams, each of which are produced and then blended at a production facility.

The variability of the composition and properties of synthetic crudes can be relatively high and more importantly cannot be characterized by static compositions obtained from static samples of the stream at a single point in time. This limitation handicaps refineries in coordinating appropriate planning and processing response to the composition of the arriving crudes, which in turn can lead to plant upsets, poor control, and unstable product quality exiting the refinery.

Another problem associated with synthetic crude is that suppliers tend to vary their operations in response to several market requirements. Thus, at any time the number and blend of synthetic crude components, or the composition of any of the components in the blend, can change. When the synthetic crude supplier changes operating parameters or component composition, it is often invisible to the refinery, even if nominal lab tests are available.

As such, there remains a need for systems and methods for creating models of composition for a composite formed by combining a plurality of hydrocarbon streams based on the limited information that is available to the refinery.

### SUMMARY OF THE INVENTION

The purpose and advantages of the present application will be set forth in and apparent from the description that follows, as well as will be learned by practice of the disclosed subject matter. Additional advantages of the disclosed subject matter will be realized and attained by the systems and apparati particularly pointed out in the written description and claims hereof, as well as from the appended drawings.

To achieve these and other advantages and in accordance with the purpose of the application, as embodied and broadly described, the disclosed subject matter includes receiving at least one primary data value; associating the at least one primary data value with a profile of the current composite; selecting a modeling scenario for the current composite; and creating a model of composition for the current composite. The at least one primary data value is related to the current composite. The modeling scenario for the current composite can be selected using a hierarchy of modeling scenarios. The selection of the modeling scenario can be based at least in part on a collection of primary data values associated with the profile of the current composite. The model of composition can be created using a processor. The creation of the model of composition for the current composite can be based at least in part on the modeling scenario and the collection of primary data values associated with the profile of the current composite.

The current composite can include, for example, a synthetic crude. The term “synthetic crude,” as used herein, refers to a petroleum stream that is synthetically constructed as a mixture of several component hydrocarbon streams each of which are produced and then blended at a production facility. The production facility is operated by a supplier that is responsible for shipping the crude to various refining facilities.

The at least one primary data value can include, for example, data related to a property of the current composite, data related to a composition of the current composite, or data related to a property of one of a plurality of hydrocarbon streams that form the current composite. Properties of the current composite can include, for example, density, sulfur distribution, and a boiling point of the current composite.

The at least one primary data value can be received from a producer of the current composite. The at least one primary data value can be received, for example, at an email system. The email can be formatted according to a customized communication protocol. The at least one primary data value can be extracted from an email using an automatic extractor. The at least one primary data value can be captured using a crude composition synchronizer. The at least one primary data value can be associated with a time stamp. The current composite can be associated with an expected time of arrival.

In certain embodiments, wet-assay data is obtained. The wet-assay data can be obtained from a refinery database or a third party database. The wet-assay data can be wet-assay data of the current composite or wet-assay data of a close surrogate of the current composite.

In accordance with one aspect, the creation of the model of composition can include obtaining a crude component template for each of the plurality of hydrocarbon streams, tuning each of the crude component templates to match at least one property of each of the plurality of hydrocarbon streams, and blending the crude component templates into a blended composition based on the relative proportions of each of the plurality of hydrocarbon streams.

As disclosed herein, the method can further include establishing a database comprising data related to at least one hydrocarbon composite. The creation of the model of composition for the current composite can be based at least in part on the modeling scenario, the collection of primary data values associated with the profile of the current composite, and a supplemental data value from the database. The database can be, for example, a plant crude database or a lab test database, and can be located in a secure computing environment. The supplemental data value can be related to the current composite or related to a composite other than the current composite. The supplemental data can be, for example, prior data or future data.

In accordance with another aspect, the creation of the model of composition can include obtaining a crude component template for each of the plurality of hydrocarbon streams, tuning each of the crude component templates to match the supplemental data value, blending the crude component templates into a blended composition based on the relative proportions of each of the plurality of hydrocarbon streams, and tuning the blended composition to match at least one property of the current composite. In another embodiment, the creation of the model of composition can include obtaining a crude component template for each of the plurality of hydrocarbon streams tuning each of the crude component templates to match at least one property of each of the plurality of hydrocarbon streams, blending the crude components templates into a blended composition based on the supplemental data values, and tuning the blended composition to match at least one property of the current composition. In a further embodiment, the creation of the model of composition can include obtaining a crude component template for each of the plurality of hydrocarbon streams, tuning each of the crude component templates to match at least one property of each of the plurality of hydrocarbon streams, blending the crude component templates into a blended composition based on the relative proportions of each of the plurality of hydrocarbon streams, and tuning the blended composition to match the supplemental data value.

As disclosed herein, the model of composition can be adjusted to match a measured data value. In another embodiment, the model of composition may be combined with a plurality of previous models of composition to determine a model of composition for a tank.

The disclosed subject matter also provides a system for creating a model of composition for a current composite formed by a plurality of hydrocarbons streams. The system includes a communications system, at least one database, and at least one processor. The communications system can receive at least one primary data value related to the current composite. The at least one database can store the at least one primary data value in association with a profile of the current composite, and can further store a hierarchy of modeling scenarios. The processor is configured to select a modeling scenario for the current composite and create a model of composition for the current composite. The modeling scenario can be selected using the hierarchy of scenarios. The selection of the modeling scenario can be based at least in part on a collection of primary data values associated with the profile of the current composite. The creation of the model of composition can be based at least in part on the modeling scenario and the collection of primary data values associated with the profile of the current composite.

It is to be understood that both the foregoing general description and the following detailed description are exemplary and are intended to provide further explanation of the application claimed.

The accompanying drawings, which are incorporated in and constitute part of this specification, are included to illustrate and provide a further understanding of the apparatus of the application. Together with the written description, the drawings serve to explain the principles of the application.

### BRIEF DESCRIPTION OF THE DRAWINGS

FIG. 1 is a flow chart describing a representative embodiment of a method of creating a model of composition for a current composite formed by combining a plurality of hydrocarbon streams in accordance with the disclosed subject matter.

FIG. 2 is a schematic diagram depicting a representative embodiment of a system used to transmit and construct a model of composition based on available information in accordance with the disclosed subject matter.

FIG. 3 is a flow chart describing a representative embodiment of a method for obtaining primary data values from a supplier in accordance with the disclosed subject matter.

FIG. 4 is an exemplary communication received from a supplier in accordance with the disclosed subject matter.

FIG. 5 is a flow chart describing a representative embodiment of a method of selecting a modeling scenario using a hierarchy of modeling scenarios in accordance with the disclosed subject matter.

FIG. 6 is a flow chart describing another representative embodiment of a method of selecting a modeling scenario using a hierarchy of modeling scenarios in accordance with the disclosed subject matter

FIG. 7 is a flow chart describing a representative embodiment of a method of selecting a modeling scenario using a hierarchy implemented as a decision tree in accordance with the disclosed subject matter.

FIG. 8 is a flow chart describing a representative embodiment of a method for creating a model of composition for a current composite in accordance with the disclosed subject matter.

FIG. 9 is a flow chart describing a representative embodiment of a method of creating a model of composition for a current composite using a first representative modeling scenario in accordance with the disclosed subject matter.

FIG. 10 is a flow chart describing a representative embodiment of a method of creating a model of composition for a current composite using a second representative modeling scenario in accordance with the disclosed subject matter.

FIG. 11 is a flow chart describing a representative embodiment of a method of creating a model of composition for a current composite using a third representative modeling scenario in accordance with the disclosed subject matter.

FIG. 12 is a flow chart describing a representative embodiment of a method of creating a model of composition for a current composite using a fourth representative modeling scenario in accordance with the disclosed subject matter.

FIG. 13 is a schematic diagram of a representative embodiment of a system for creating a model of composition for a current composite in accordance with the disclosed subject matter.

### DETAILED DESCRIPTION OF THE PREFERRED EMBODIMENT

Reference will now be made in detail to the present preferred embodiments of the disclosed subject matter, examples of which are illustrated in the accompanying drawings. The systems and methods presented herein generally are intended for creating a model of composition for a synthetic composite.

In accordance with the disclosed subject matter, a method for creating a model of composition for a current composite created by combining a plurality of hydrocarbon steams is provided. The method includes receiving at least one primary data value related to the current composite; associating the at least one primary data value with a profile of the current composite; selecting a modeling scenario for the current composite using a hierarchy of modeling scenarios; and creating a model of composition for the current composite using at least one processor. The modeling scenario is selected based at least in part on a collection of primary data values associated with the profile of the current composite. The model of composition is created based at least in part on the modeling scenario and the collection of primary data values associated with the profile of the current composite.

Likewise, and in accordance with another aspect of the disclosed subject matter, a system is provided for creating a model of composition for a current composite created by combining a plurality of hydrocarbon steams. The system comprises a communications system, at least one database, and at least one processor. The communications system receives the at least one primary data value related to the current composite. The at least one database stores the at least one primary data value in association with a profile of the current composite, and stored a hierarchy of modeling scenarios. The at least one processor selects, using the hierarchy of modeling scenarios, a modeling scenario for the current composite based at least in part on a collection of primary data values associated with the profile of the current composite. The at least one processor further creates a model of composition for the current composite based at least in part on the modeling scenario and the collection of primary data values associated with the profile of the current composite.

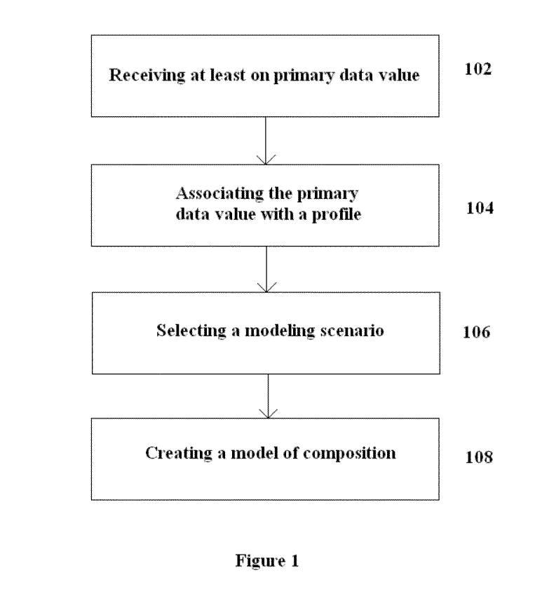

For purpose of explanation and illustration, and not limitation, an exemplary embodiment of the method and system for creating a model of composition in accordance with the application is shown in FIGS. 1 through 13.

With reference to FIG. 1, the at least one primary data value related to the current composite is received. (See 102). As used herein, the term “current composite” refers to the composite for which a model of composition is being created. The system therefore can receive and store information on a number of composites at the same time, so there can be a number of composites for which the system is storing information at any given point.

The term “primary data value” refers to any data value that is related specifically to the current composite. For purposes of example, and not limitation, the primary data value can be a data value related to a property of the current composite, a composition of the current composite, or a property of one of a plurality of hydrocarbon streams that form the current composite. For example, the primary data value can be a data value representing the density of the current composite, the sulfur distribution of the current composite, or the boiling point of the current composite.

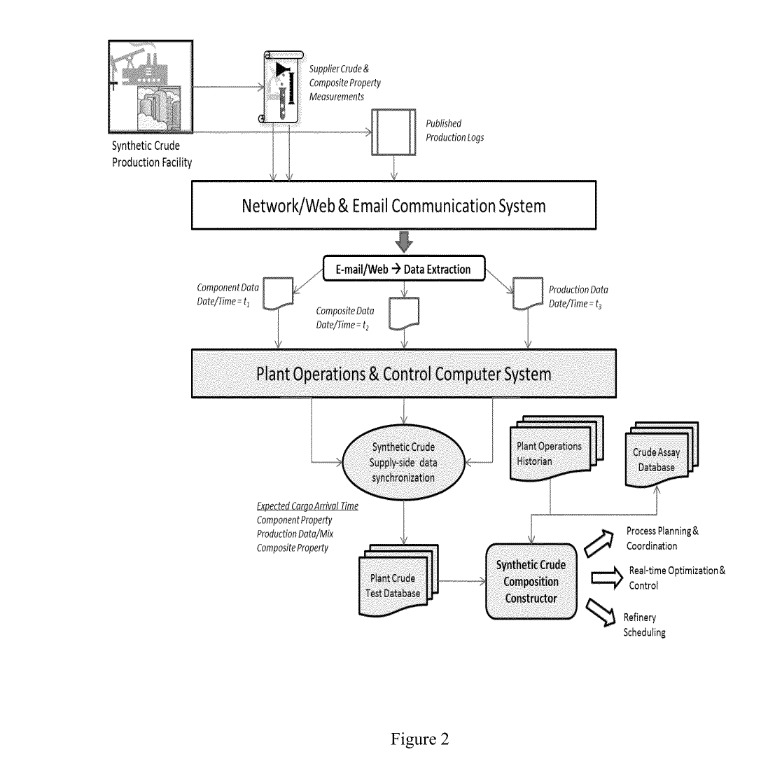

In conjunction with the disclosed method, FIG. 2 depicts a representative system for receiving primary data values and constructing a model of composition is disclosed. For purposes of illustration and not limitation, the system generally includes two portions: the communication system 202 and the operations and control computer system 204, as discussed in further detail and in conjunction with the disclosed method.

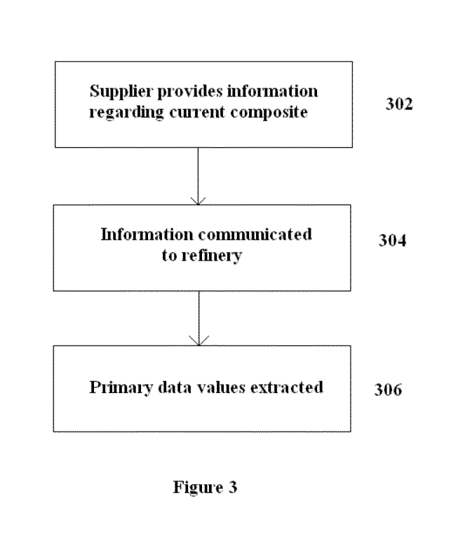

With reference to FIG. 3, the supplier can provide information about the current composite. (See 302). This information may include, for example, production logs that contain information regarding the operating conditions of the production of each component, component property data measured at the production facility, bulk property measurements on cargoes taken before the cargoes (i.e., composites) are introduced into the supply pipeline, or any other information that the supplier is able to obtain.

This information can then be communicated to the refinery using any of a variety of suitable methods. (See 304). The term “refinery,” as used herein, refers broadly to the party that creates and uses the model of composition. In some cases, the term “refinery” refers to a single party. In other embodiments, the refinery can be a combination of the party that operates refinery operations (the customer/refiner) and one or more additional parties working with the operating party. For example, the customer/refiner can designate or rely on a third party to provide one or more services including storage of information received from the supplier, creation of the model of composition, and planning of refinery operations based on the models of composition for incoming synthetic composites.

In one embodiment, the information can be communicated to the customer/refiner's email system 202 or other electronic communication system. As shown in FIG. 2, the email/communications system can receive supplier crude and composite property measurements, published production logs, and other relevant information from the supplier and extract various data points from those communications. The customer/refiner and the supplier can establish a common communication protocol such that all communications containing primary data values related to a composite are in the same format. The communication can be, e.g., an email or other electronic message.

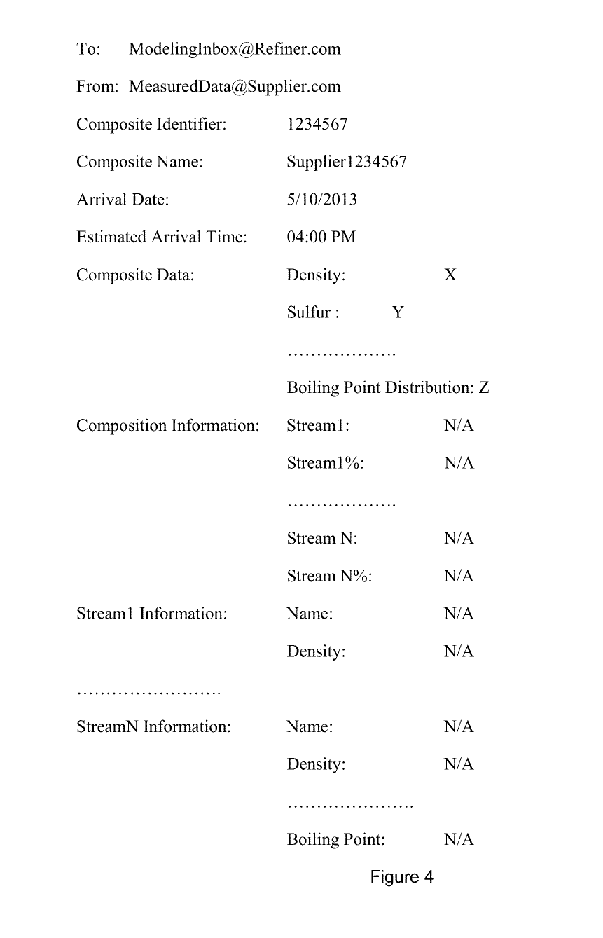

With reference to FIG. 4, a communication 400 in a common communication protocol can include a number of data fields. For example, communication 400 can include a data field, such as an addressee field 402, indicating that the communication 400 includes primary data values for a composite and prompting an automatic extractor to extract information from the communication 400. Other information, such as an identification number or information in the header, can be used instead of or in addition to the addressee name.

Communication 400 can also include a sender address field 404. The sender address field 404 can be used in addition to the addressee field 402 to indicate that the communication 400 includes primary data values for a composite. The sender address field 404 can also be used to confirm that the sender has access to the information provided in the communication 400. For example, if the sender address 404 of a communication 400 including information about a particular composite does not match the address of the supplier of the particular composite, the system can indicate that the information may be unreliable.

The communication 400 can also include identifiers for the composite. The identifiers can include a composite identification number field 406, a composite name field 408, an arrival date field 410, and an estimated arrival time field 412. The identifiers can be used to identity the particular composite to which the primary data values relate. The arrival date and estimated arrival time can also be used to update the refinery's records if any delay has occurred or is anticipated to occur since the last communication between the supplier and the customer/refinery.

The communication 400 also includes at least one primary data value. The communication 400 can include a set number of data fields that include either data values or an indication that no data value has been provided. For example, a data field can be labeled as “*” or “N/A” to indicate that no data value has been provided for a particular data field.

Primary data value fields in the communication 400 can be divided into composite data fields 414, composition data fields 416, and components data fields 418. Composite data fields 414 can include information about the composite as a whole. For example, composite data fields 414 can include the results of bulk property, measurements that the supplier takes before the composite is inserted into the supply pipeline. Composite data fields 414 can include data values for the density of the composite, the sulfur distribution of the composite, the boiling point distribution of the composite, or any other information about the composite such as concarbon and nitrogen. Component data fields 418 include the bulk property measurements such as gravity, boiling-point cut that the supplier might measure on the components themselves. They may also be averaged properties over a short period of time (such as a day or week) of stable operation at the supplier's facility. Composition data fields are usually prior or last known detailed information on the stream that may include partial compositional information. These are usually measured at the refinery lab. For instance, the paraffin-naphthene-aromatic (PNA) compositional information may be available from a previous measurement.

Composition data fields 416 can include information related to the relative proportions of each of the plurality of component hydrocarbon streams. More generally, this type of information can be referred to as proportion data. The term “component hydrocarbon stream,” as used herein, refers to any of the plurality of hydrocarbon streams that are combined to form a composite. The composition data fields 416 can include, for example, the relative weights or volumes of the components in the composite. This information can be received in the form of production logs provided by the supplier.

Components data fields 418 can include any information related to the properties of the components hydrocarbon streams. Thus, the components data fields can include the same information as discussed above with respect to the composite data field, except for each of the plurality of component hydrocarbon streams rather than for the composite as a whole. The components data fields can be populated based on the production logs provided by the supplier or based on component property data measured at the production facility.

While the communication format is disclosed herein with reference to FIG. 4, a person having ordinary skill in the art will recognize that a wide variety of standard communication protocols, and methods for implementing the same, can be used without departing from the scope of the disclosed subject matter.

As further shown in FIG. 3, information, including the primary data values, is extracted from the information provided to the modeler/refinery/customer. (See 306). An automatic extractor can be used to extract the primary data values and other information from the formatted communications.

The at least one primary data value is then associated with a profile of the current composite. (See 104). The primary data value can be stored in a data field of the profile, stored in a separate file with a reference to the separate file stored in the profile, or in any other manner known in the art.

The profile of the current composite is an aggregation of all available information the system has obtained regarding the current composite. For example, the profile can contain identification information about the current composite such as the supplier, an identification number, a composite name, an arrival date, or an estimated time of arrival. The profile can also contain a plurality of previous primary data field values supplied by the supplier. The profile can include a model of composition created by the system. The profile can further include any other information received from the supplier, created by the system, input by a user, or otherwise obtained by the system. In some embodiments, the profile can also contain information related to compositions other than the current composition. For example, the profile can contain information about a composition that is similar to, or a close surrogate of, the current composite.

In one embodiment, the system can create a profile for a current composite when the customer/refiner places the order for the current composite, or at another time before receipt of the primary data value, such that the primary data value will always be associated with an existing profile. Additionally or alternatively, the system can create a profile for a current composite upon receiving a first primary data value related to the current composite. In such a situation, the system can use a blank template and use the information provided by the supplier—including the identification information and the primary data values—to establish a profile for the current composite. The new profile can contain a generic model of composition, a model of composition created based on the limited information received to date, if possible, or no model of composition at all.

A modeling scenario for the current composite is selected using a hierarchy of modeling scenarios based at least in part on a collection of primary data values associated with the profile of the current composite. (See 106). As used herein, the term “hierarchy of modeling scenarios” broadly refers to an ordered set of three or more modeling scenarios.

As used herein, the term “collection of primary data values” refers to one or more primary data values. The collection of primary values can be a single primary data value received from the supplier. The collection of primary values can also be a plurality of primary data values received either separately or simultaneously. The modeling scenario can be selected based on whether a particular primary data value (or group of primary data values) has been received by the system. The modeling scenario can be selected based on a collection of primary data values that is smaller than the number of primary data values stored in association with the profile of the current composite.

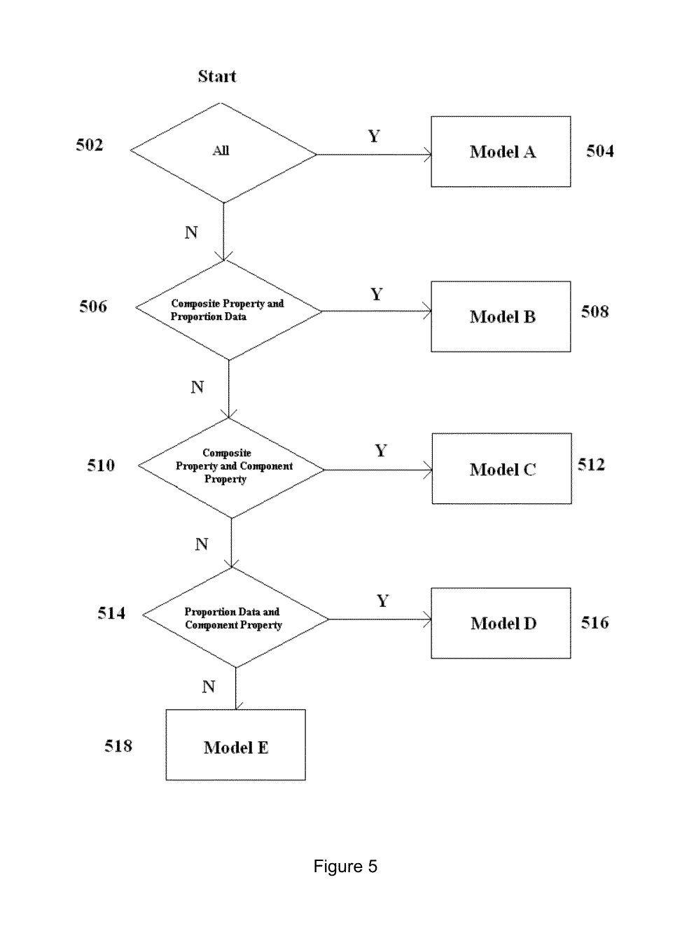

With reference to FIG. 5, an exemplary hierarchy is disclosed. The exemplary hierarchy of FIG. 5 is described with reference to three categories of data values: properties of the current composite, relative proportions of each of a plurality of component hydrocarbon streams in the current composite, and the properties of each of the plurality of component hydrocarbon streams. However, it is possible that the refinery can obtain data values for properties of one of the plurality of component hydrocarbon streams without obtaining data values for properties of all of the plurality of component hydrocarbon streams. The hierarchy can be designed to take into account these variations. However, for purpose of simplicity and explanation, the exemplary hierarchy of FIG. 5 is described as though each of these three categories of data is either satisfied or not satisfied.

In FIG. 5, the method and system first determines whether the profile for the current composite includes data values for all three categories of data values. (See 502). If so, Model A is used. (See 504). If not, the method and system determines whether the profile for the current composite includes data values for the properties of the current composite and the relative proportions of each of a plurality of component hydrocarbon streams in the current composite. (See 506). If so, Model B is used. (See 508). If not, the method and system determines whether the profile for the current composite includes data values for the properties of the current composite and the properties of each of the plurality of component of hydrocarbon streams. (See 510). If so, Model C is used. (See 512). If not, the method and system determines whether the profile for the current composite includes the relative proportions of each of a plurality of component hydrocarbon streams in the current composite and properties of each of a plurality of component hydrocarbon streams. (See 514). If so, Model D is used. (See 516). If not, Model E is used. (See 518). Each of these models is described in further detail below.

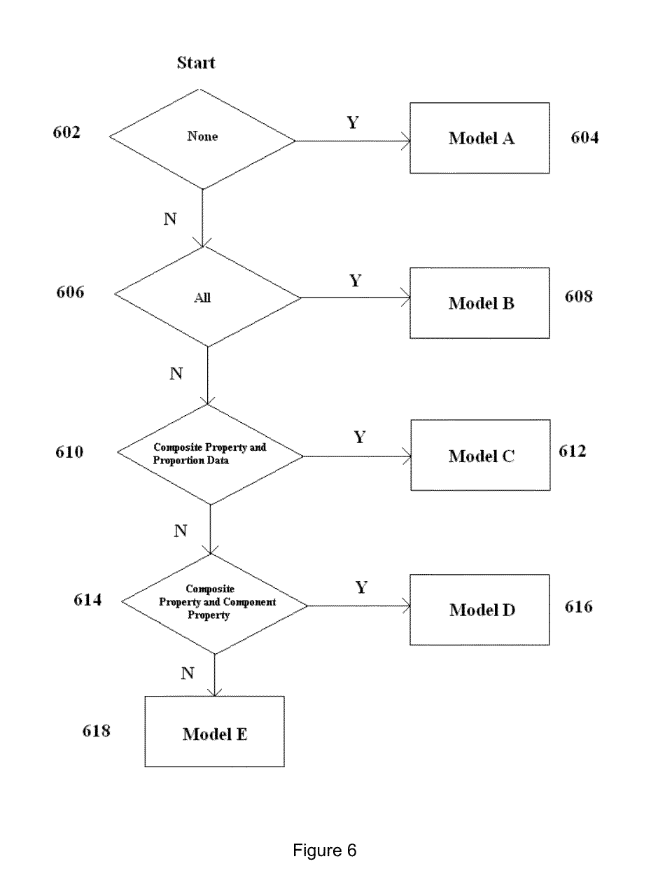

It is recognized that other designs or structures for the hierarchy are possible can be used or configured for the intended purpose and based upon the available information. For example, the order of the hierarchy can be varied based on the preferences of the user. An exemplary embodiment of an alternative hierarchy is disclosed in FIG. 6. Unlike FIG. 5, FIG. 6 discloses a hierarchy wherein the first query 602 is whether the system has no data. A system can be designed to use this query first where, for example, information is rarely made available from the supplier, so as to make the process more efficient. FIG. 6 also does not include a query corresponding to query 514 in FIG. 5. The system can be designed so as to omit or add any possible queries without departing from the scope of the disclosed subject matter.

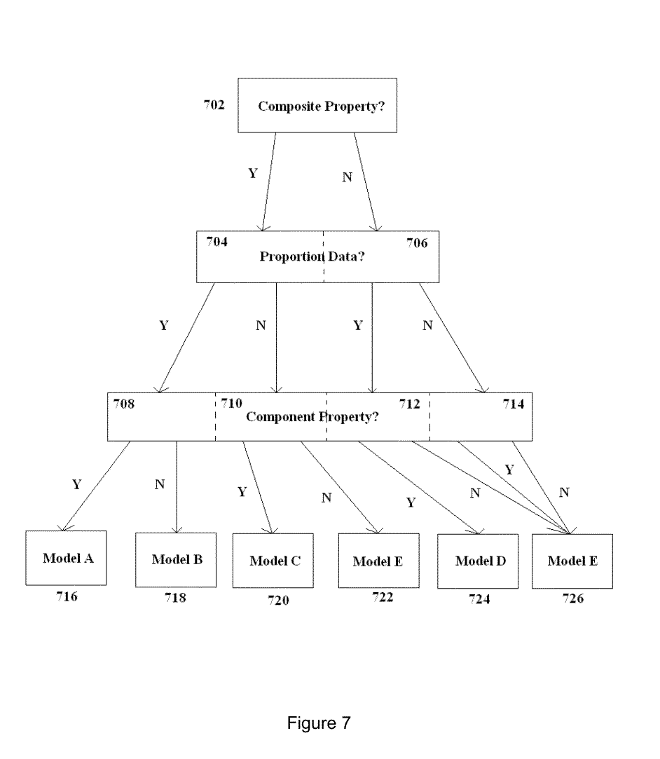

With reference to FIG. 7, the hierarchy can alternatively be configured or structured as a decision tree. The hierarchy of FIG. 7 will reach the same result as the hierarchy of FIG. 5, but by an alternative design and implementation in accordance with the disclosed subject matter. Additional or alternative hierarchies can be designed and implemented in a variety of ways within the scope of the disclosed subject matter.

Using the available information and selected modeling scenario, a model of composition for the current composition is then creating using at least one processor. (See 108). The model of composition can be created based at least in part on the selected modeling scenario and the collection of primary data values associated with the profile of the current composite.

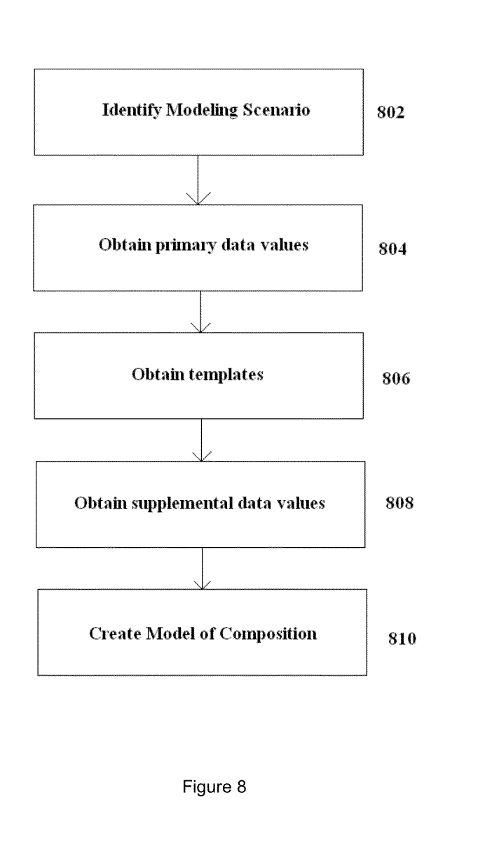

With reference to FIG. 8, an exemplary embodiment of the process for creating the model of composition is generally disclosed. After identifying the appropriate modeling scenario as introduced briefly above and described in further detail herein, (See 802), the required primary data values are then obtained from the profile of the current composite. (See 804). The required primary data values will depend on the modeling scenario. To the extent possible, all primary data values stored with the profile of the current composite can be used. Based on the available information and selected modeling scenarios, any template for creation of the model of composite are then obtained as needed. (See 806). A template would consist of at least an identification header and a composition header. The identification header or tag would uniquely identify the stream and type. The composition header will contain the prior measured (or estimated) composition information pertaining to the stream or type such as a known set of components and their relative proportions. The components will be from a pre-defined set of cuts, lumps or molecular species. The composition header may have a date and time stamp listing the date when this prior composition was measured or constructed. For instance, the method and system can include a template model of composition for each of the plurality of component hydrocarbon streams. The templates can be stored in a local database by the refinery or obtained from an external database.

Additionally, any supplemental data that is necessary for creation of the model is obtained. (See 808). Supplemental data, as used herein, refers to data related to a hydrocarbon stream other than the current composite (the “supplemental hydrocarbon stream”). The supplemental hydrocarbon stream can be a supplemental composite. For purposes of explanation and not limitation, supplemental data can be obtained from publicly available information about well-known hydrocarbon streams, measurements of other hydrocarbon streams available from the supplier, measurements of or other information related to a close surrogate of the current composite, or data related to any other hydrocarbon stream. In a preferred embodiment, the supplemental data relates to either a composite identified by the supplier as being closely related or a composite that shares similar characteristics (e.g., the same component hydrocarbon streams or similar composite properties) with the current composite.

The supplemental data value can be any property of the supplemental hydrocarbon stream. The supplemental data values can include, for example, properties of a supplemental composite, relative proportions of each of the plurality of hydrocarbon streams that form the supplemental composite, or properties of a supplemental hydrocarbon stream.

After obtaining all necessary information, the model of composition is created. (See 810).

For purpose of illustration, application of the method and system disclosed herein is provided in further detail with reference to each respective modeling scenario embodied herein, i.e., Model A-Model E.

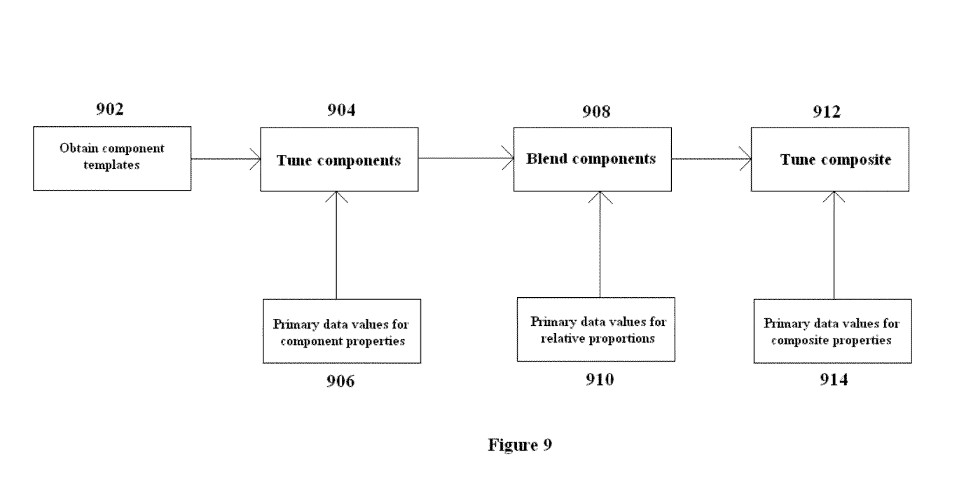

For example, with reference to FIG. 5, assume that Model A is selected as the appropriate modeling scenario. Model A is described for purposes of explanation in FIG. 9. Model A, in this example, utilizes the data values for the properties of the current composite, relative proportions of each of a plurality of component hydrocarbon streams in the current composite, and the properties of each of the plurality of component hydrocarbon streams. Thus, this information can be retrieved from the profile of the current composite. Model A also uses crude component templates for each of the plurality of hydrocarbon streams in the current composite. No supplemental data is used or needed in connection with Model A.

With reference to FIG. 9, crude component templates are obtained for each of the plurality of hydrocarbon streams in the current composite. (See 902). Each of the plurality of crude component templates is then tuned to match the at least one property of each of the plurality of hydrocarbon streams. (See 904). The at least one property of each of the plurality of hydrocarbon streams are, in Model A, primary data values retrieved from the profile of the current composite. (See 906).

For example, assume for purpose of illustration and not limitation that the profile for the current composite includes information that Hydrocarbon Stream A has a density of X kg/m³. The composition of the crude composite as characterized by relative percentages of pseudo-cuts, lumps or molecular species will be tuned such that the predicted density resulting from the new model of composition for Hydrocarbon Stream A will be close to X kg/m³. As used herein, the term “tuned” generally refers to constrained or unconstrained adjustments of the relative proportions of the components used to describe the model of composition of the hydrocarbon stream. This typically involves a constrained least-squares optimization procedure that adjusts the composition to minimize the combine deviation between all predicted and measured properties.

The tuned crude component templates are then blended in relative proportion to the each of the corresponding plurality of hydrocarbon streams to get a blended composition. (See 908). The relative proportions of each of the plurality of hydrocarbon streams are, in Model A, primary data values retrieved from the profile of the current composite. (See 910).

The blended composition is then tuned to match at least one property of the current composite. (See 912). The tuning of the blended composition can be accomplished in the same manner as described above for the crude component templates. The at least one property of the current composite is, in Model A, a primary data value retrieved from the profile of the current composite. The blended composition, further tuned based on the at least one property of the current composite, is thus used as the model of composition for the current composite in Model A.

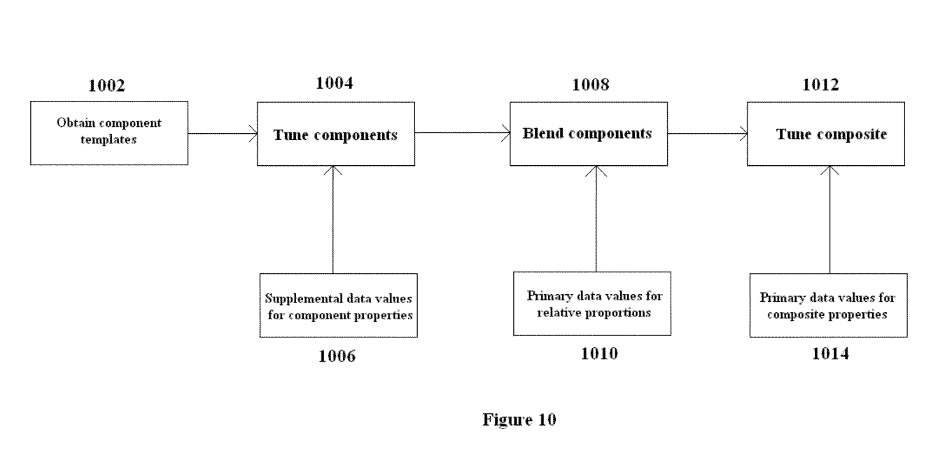

With reference to FIG. 5, assume now that Model B is selected. An exemplary embodiment of Model B is disclosed in FIG. 10. Model B can use primary data values for the at least one property of the current composite and the relative proportions of each of the plurality of component hydrocarbon streams, crude component templates for each of the plurality of the component hydrocarbon streams, and supplemental data values for the properties of the plurality of component hydrocarbon streams.

With reference to FIG. 10, crude component templates are obtained for each of the plurality of hydrocarbon streams in the current composite. (See 1002). Each of the plurality of crude component templates is then tuned to match a supplemental data value 1006. (See 1004). The supplemental data value 1006 for a particular component hydrocarbon stream can be, for example, a measurement from a hydrocarbon stream that is similar to the component hydrocarbon stream or data related to a prior, future, or otherwise different component hydrocarbon stream received from the supplier. As used herein, the term “prior” refers to data relating to an earlier hydrocarbon stream (e.g., a synthetic composite that was blended prior to the current composite). The term “future” refers to data relating to a later hydrocarbon stream (e.g., a synthetic composite that was blended after the current composite). The term “different” refers to data related to a hydrocarbon stream other than the current stream of investigation. The measurement can be, for example, a density measurement, a sulfur composition measurement, or a boiling point measurement. Alternatively, the tuning step can be skipped when primary data values for each of the plurality of component hydrocarbon streams are not available. In a further embodiment, primary data values may be available for some but not all of the plurality of component hydrocarbon streams. The primary data values can be used where available, and the remaining crude component templates can be tuned, if at all, using supplemental data values. In yet another embodiment, the system can determine whether to use a supplemental data value based on data supplied by the supplier (e.g., whether the supplier has identified a close surrogate) or other relevant criteria.

The tuned crude component templates are then blended into a blended composition based on the relative proportions of each of the plurality of hydrocarbon streams. (See 1008). The relative proportions of each of the plurality of hydrocarbon streams are, in Model B, primary data values retrieved from the profile of the current composite. (See 1010).

Finally, the blended composition is tuned to match at least one property of the current composite. (See 1012). The at least one property of the current composite is, in Model B, a primary data value retrieved from the profile of the current composite. (See 1014). The blended composition, further tuned to match at least one property of the current composite, is thus used as the model of composition for the current composite in Model B.

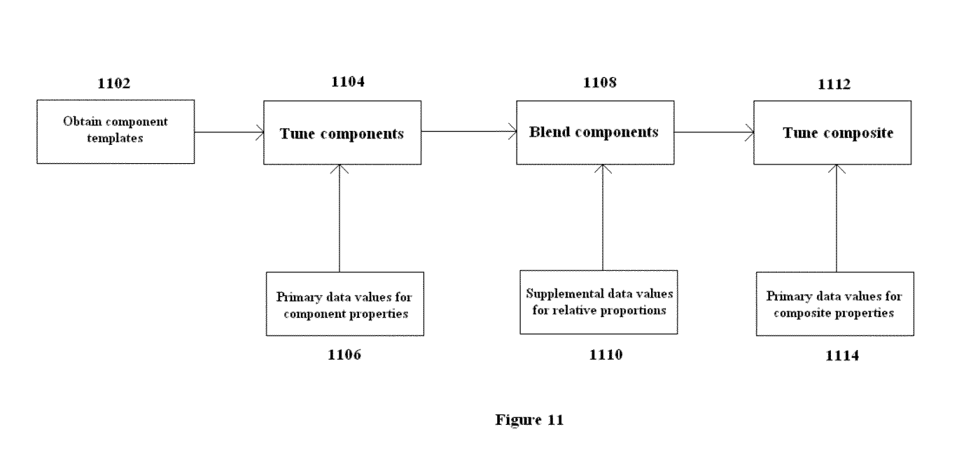

With reference to FIG. 5, assume now that Model C is selected. An exemplary embodiment of Model C is disclosed in FIG. 11. Model C can use primary data values for the at least one property of the current composite and at least one property of each of the plurality of component hydrocarbon streams, crude component templates for each of the plurality of the component hydrocarbon streams, and supplemental data values for the relative proportions of the plurality of component hydrocarbon streams.

With reference to FIG. 11, crude component templates are obtained for each of the plurality of hydrocarbon streams in the current composite. (See 1102). Each of the plurality of crude component templates is then tuned to match the properties of the plurality of hydrocarbon streams. (See 1104). The at least one property of each of the plurality of hydrocarbon streams are, in Model C, primary data values retrieved from the profile of the current composite. (See 1106). The blended composition, further tuned to match at least one property of the current composite, is thus used as the model of composition for the current composite in Model B.

The tuned crude component templates are then blended into a blended composition based on a supplemental data value 1110. (See 1108). The supplemental data values 1110 can be, for example, relative weights or volumes of a supplemental composite. The supplemental composite can be, for example, a composite that has been identified as similar to the current composite, or the composite for which the system has recently received proportion data.

The blended composition is then tuned to match at least one property of the current composite. (See 1112). The at least one property of the current composite is, in Model C, a primary data value retrieved from the profile of the current composite. (See 1114). The blended composition, further tuned to match at least one property of the current composite, is thus used as the model of composition for the current composite in Model C.

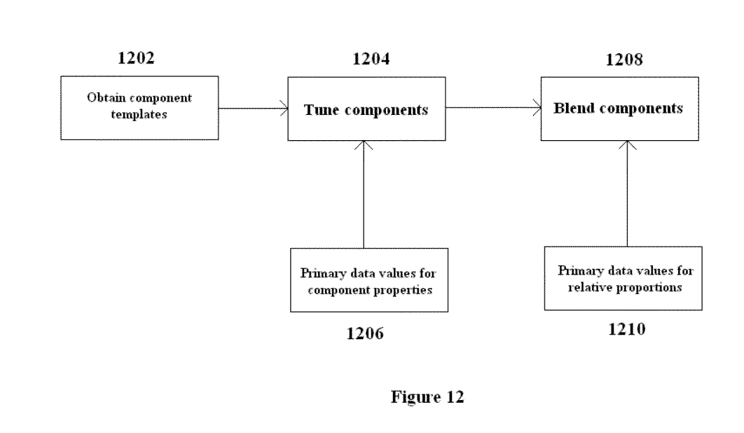

With reference to FIG. 5, Model D can be selected. An exemplary embodiment of Model D is disclosed in FIG. 12. Model D can use primary data values for the at least one property of each of the plurality of component hydrocarbon streams and the relative proportions of each of the plurality of component hydrocarbon streams, crude component templates for each of the plurality of the component hydrocarbon streams, and supplemental data values for the properties of the current composite.

With reference to FIG. 12, crude component templates are obtained for each of the plurality of hydrocarbon streams in the current composite. (See 1202). Each of the plurality of crude component templates is then tuned to match the properties of the plurality of hydrocarbon streams. (See 1204). The at least one property of each of the plurality of hydrocarbon streams are, in Model D, primary data values retrieved from the profile of the current composite. (See 1206).

The tuned crude component templates are then blended into a blended composition based on the relative proportions of the plurality of hydrocarbon streams. (See 1208). The relative proportions of each of the plurality of hydrocarbon streams are, in Model D, primary data values retrieved from the profile of the current composite. (See 1210). The blended composition can then used as the model of composition for the current composite.

As embodied herein, the blended composition can be tuned to match a supplemental data value. Additionally or alternatively, the method and system disclosed herein can determine whether the blended composition should be tuned based on information received from the supplier (e.g., an identification of a close surrogate) or other criteria. The blended composition, whether or not further tuned to match the supplemental data value, can thus be used as the model of composition for the current composite in Model D.

With reference to FIG. 5, assume now that Model E is selected. In an exemplary embodiment, for illustration and not limitation, static wet assay data is used as the model of composition for the current composite when no other data is available for the current composite, or when the data in the profile is insufficient to use any of the other models.

Other modeling scenarios can also be used within the scope of the disclosed subject matter. Minor adjustments to the disclosed modeling scenarios can be made, or other modeling scenarios can be added or omitted, depending on the availability of information, the preferences of the user, and other considerations. Hence, a wide range of modeling scenarios can be used in connection with the disclosed subject matter without departing from the scope of the disclosed subject matter.

The model of composition can then be stored in the profile of the current composite. The model of composition can be stored in any storage device, including a hard drive, a memory portion, or any other storage device as known in the art.

The model of composition stored with each incoming composite can then be used to plan refinery operations. For example and not limited to, compositional information can be used, among other things, for the following purposes: (a) to make better decisions when optimizing process operations based on the estimated property distribution in a stream, e.g., sulfur content; (b) to better monitor the health and reliability of equipment by providing a more accurate understanding of the equipment's feed conditions; and (c) to enhance the accuracy of compositional-based optimization systems, such as real-time optimization systems that run on an on-line process control computer that simultaneously optimize economics while mitigating disturbances. (d) Another example would be use of the dynamic (look-ahead) compositional information in planning and scheduling. For example, refinery run-plans and schedules can be altered based on the look-ahead compositional information such as the arrival of a heavier than expected feed to produce or purchase additional lighter blend components to meet product quality requirements.

When the refinery receives a new shipment of synthetic crude, the refinery can obtain the model of composition for that synthetic crude and indicate in the system that the synthetic crude has arrived. The synthetic crude can be identified by any identifier as previously discussed, such as an identification number, a batch name, a date and time of arrival, or any other identifying information. The refinery can update its operations models based on the exact time of receipt.

The refinery can take measurements of the received synthetic crude. These measurements can include bulk-properties such as but not limited to gravity, sulfur, nitrogen, TAN etc. These can extend to distributional properties that may be measured in a lab or online such as boiling-point, GC-PIONA etc. The model of composition stored with the profile of the received synthetic crude can then be updated (i.e., tuned) to match the measurements at the refinery. Refinery run plans can be fine-tuned based on the adjusted model of composition for the received synthetic crude.

The synthetic crude can then be introduced into the refinery operations. For example, the synthetic crude can be added to a tank that already contains a crude product. The model of composition for the tank can be created by combining the models of composition for the various crudes in the tank. The model of composition for the tank can then be updated by tuning the model of composition based on measurements taken from the tank.

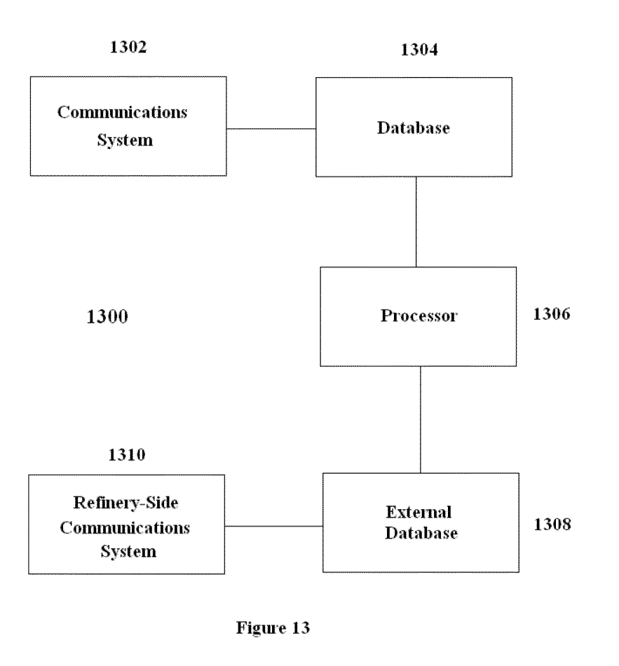

For purpose of explanation and illustration, and not limitation, an exemplary embodiment of the system for creating a model of composition in accordance with the application is shown in FIG. 13. Generally, and with reference to FIG. 13, the system includes a communications system 1302, a database 1304, and at least one processor 1306.

The communications system 1302 can be any system capable of receiving information from an outside source. The communications system 1302 can be, for example, an email system or a user interface. The communication system can receive information, such as production logs, component property data, and bulk property measurements, from the supplier, either directly or indirectly. The communication system can, for example, include a network interface to allow communication between the Internet and the system 1300 or can be a dedicated line if desired. The communication system 1300 can include a transceiver for receiving and transmitting information to and from the system 1300. The communication system 1300 can include an automatic extractor designed to extract relevant information from communications such as emails or the like. As previously described, the communications can be formatted in a standard communication protocol. The communication system 1302 can also include security features such as a firewall or a decryption mechanism to decode encrypted messages. The communication system 1302 can include these and other components using any systems as known in the art for their intended purpose.

The database 1304 can be any storage medium as known in the art. For example, the database 1304 can be a memory portion of a hard drive, a sever, or an external storage medium such as an external hard drive or a USB storage device. The database 1304 can also be a plurality of databases located locally and/or remotely, such that a plurality of storage devices are combined to store the relevant information. The database 1304 can store the profiles of the various composites and the hierarchy of modeling scenarios. The database 1304 can also store computer code with instructions for implementing the disclosed subject matter.

The at least one processor 1306 comprises one or more circuits. The one or more circuits can be designed so as to implement the disclosed subject matter using hardware only. Alternatively, the processor can be designed to carry out the instructions specified by the computer code stored in a hard drive, a removable storage medium, or any other database. The processor 1306 can also be referred to as the synthetic crude composition constructor, as shown in FIG. 2. In another embodiment, the at least processor 1306 can include multiple processors including the synthetic crude composition constructor and a separate modeling scenario selection processor. Additional processors can be added to perform the additional processes disclosed herein, or these additional processes can be performed by the processor 1306. For example, the at least one processor can be used to plan refinery operations based on the model of compositions created by the synthetic crude composition constructor shown in FIG. 2.

The system 1300 can also access external databases 1308. The external databases 1308 can include, for example, a crude assay database and a plant operations historian database as shown in FIG. 2. In another embodiment, the crude assay database and the plant operations historian database are combined with the plant crude test database to form the at least one database 1304.

The system 1300 can also include a number of additional components, including a refinery-side communications system 1310 for receiving additional information regarding the current composite from the refinery when the composite arrives at the refinery. The refinery-side communications system 1310 can include, for example, a user interface that allows shipping coordinators, engineers, or other employees of the refinery to enter information about the received synthetic composite.

In accordance with another aspect of the disclosed subject matter, a non-transitory computer-readable medium can be provided comprising a set of programming instructions that, when executed, cause the at least one processor 1306 to perform the method disclosed herein. The non-transitory computer-readable medium can be, for example, a computer storage chip such as a USB flash drive, optical media such as a compact disc, or other non-transitory computer-readable media as known in the art.

While the present application is described herein in terms of certain preferred embodiments, those skilled in the art will recognize that various modifications and improvements may be made to the application without departing from the scope thereof. Thus, it is intended that the present application include modifications and variations that are within the scope of the appended claims and their equivalents. Moreover, although individual features of one embodiment of the application may be discussed herein or shown in the drawings of one embodiment and not in other embodiments, it should be apparent that individual features of one embodiment may be combined with one or more features of another embodiment or features from a plurality of embodiments.

In addition to the specific embodiments claimed below, the application is also directed to other embodiments having any other possible combination of the dependent features claimed below and those disclosed above. As such, the particular features presented in the dependent claims and disclosed above can be combined with each other in other manners within the scope of the application such that the application should be recognized as also specifically directed to other embodiments having any other possible combinations. Thus, the foregoing description of specific embodiments of the application has been presented for purposes of illustration and description. It is not intended to be exhaustive or to limit the application to those embodiments disclosed.

1. A method for creating a model of composition for a current composite formed by combining a plurality of hydrocarbon streams, the method comprising:
receiving at least one primary data value related to the current composite;
associating the at least one primary data value with a profile of the current composite;
selecting, using a hierarchy of modeling scenarios, a modeling scenario for the current composite based at least in part on a collection of primary data values associated with the profile of the current composite; and
creating, using at least one processor, a model of composition for the current composite based at least in part on the modeling scenario and the collection of primary data values associated with the profile of the current composite.

2. The method of claim 1, wherein the at least one primary data value comprises data related to a property of the current composite.

3. The method of claim 2, wherein the property of the current composite comprises one of a density, a sulfur distribution, and a boiling point of the current composite.

4. The method of claim 1, wherein the at least one primary data value comprises data related to a composition of the current composite.

5. The method of claim 1, wherein the at least one primary data value comprises data related to a property of one of a plurality of hydrocarbon streams that form the current composite.

6. The method of claim 1, wherein the at least one primary data value is received from a producer of the current composite.

7. The method of claim 1, wherein receiving the at least one primary data value comprises receiving the at least one primary data value at a communication system.

8. The method of claim 7, wherein receiving the at least one primary data value further comprises extracting the at least one primary data value from a communication using an automatic extractor.

9. The method of claim 7, wherein the communication is formatted according to a customized communication protocol.

10. The method of claim 1, wherein the current composite comprises a synthetic crude.

11. The method of claim 1, further comprising capturing the at least one primary data value using a crude composition synchronizer.

12. The method of claim 1, wherein the at least one primary data value is associated with a time-stamp.

13. The method of claim 1, wherein the current composite is associated with an expected time of arrival.

14. The method of claim 1, further comprising obtaining wet-assay data.

15. The method of claim 14, wherein the wet-assay data is obtained from a refinery database.

16. The method of claim 14, wherein the wet-assay data is obtained from a third party database.

17. The method of claim 14, wherein the wet-assay data comprises wet-assay data of the current composite.

18. The method of claim 14, wherein the wet-assay data comprises wet-assay data of a close surrogate of the current composite.

19. The method of claim 1, wherein creating the model of composition comprises:
obtaining a crude component template for each of the plurality of hydrocarbon streams;
tuning each of the crude composition templates to match at least one property of each of the plurality of hydrocarbon streams; and
blending the crude component templates into a blended composition based on relative proportions of each of the plurality of hydrocarbon streams.

20. The method of claim 1, further comprising combining the model of composition with a plurality of previous models of composition to determine a model of composition for a tank.

21. The method of claim 1, further comprising adjusting the model of composition to match a data value measured at the refinery.

22. The method of claim 1, further comprising:
establishing a database comprising data related to at least one hydrocarbon composite,
wherein creating the model of composition for the current composite is based at least in part on the modeling scenario, the collection of primary data values associated with the profile of the current composite, and a supplemental data value from the database.

23. The method of claim 22, wherein the database comprises a plant crude database.

24. The method of claim 22, wherein the database comprises a lab test database.

25. The method of claim 22, wherein the database is located in a secure computing environment.

26. The method of claim 22, wherein the supplemental data value is related to a composite other than the current composite.

27. The method of claim 22, wherein the supplemental data value is related to the current composite.

28. The method of claim 22, wherein the supplemental data value comprises a data value related to a composite produced by the same supplier that produced the current composite.

29. The method of claim 22, wherein the supplemental data value comprises prior data.

30. The method of claim 22, wherein the supplemental data value comprises future data.

31. The method of claim 22, wherein creating the model of composition comprises:
obtaining a crude component template for each of the plurality of hydrocarbon streams;
tuning each of the crude component templates to match the supplemental data value;
blending the crude component templates into a blended composition based on relative proportions of each of the plurality of hydrocarbon streams; and
tuning the blended composition to match at least one property of the current composite.

32. The method of claim 22, wherein creating the model of composition comprises:
obtaining a crude component template for each of the plurality of hydrocarbon streams;
tuning each of the plurality of crude component templates to match at least one property of each of the plurality of hydrocarbon streams;
blending the crude component templates into a blended composition based on the supplemental data value; and
tuning the blended composition to match at least one property of the current composition.

33. The method of claim 22, wherein creating the model of composition comprises:
obtaining a crude component template for each of the plurality of hydrocarbon streams;
tuning each of the crude composition templates to match at least one property of each of the plurality of hydrocarbon streams;
blending the crude component templates into a blended composition based on relative proportions of each of the plurality of hydrocarbon streams; and
tuning the blended composition to match the supplemental data value.

34. A system for creating a model of composition for a current composite created by combining a plurality of hydrocarbon streams, the system comprising:
a communications system for receiving at least one primary data value related to the current composite;
at least one database for storing the at least one primary data value in association with a profile of the current composite, the at least one database further storing a hierarchy of modeling scenarios; and
at least one processor configured to
select, using the hierarchy of modeling scenarios, a modeling scenario for the current composition based at least in part on a collection of primary data values associated with the profile of the current composite; and
create a model of composition for the current composite based at least in part on the modeling scenario and the collection of primary data values associated with the profile of the current composite.
